(19) United States
(12) Patent Application Publication
(10) Pub. No.: US 2017/0254965 A1
(43) Pub. Date: Sep. 7, 2017

(54) OPTICAL FIBRE CONNECTOR PLUG AND ASSEMBLY METHOD THEREFOR

(71) Applicant: SUNSEA TELECOMMUNICATIONS CO., LTD., Shenzhen (CN)

(72) Inventors: Jiangbo QIN, Shenzhen (CN); Shuilan HE, Shenzhen (CN); Qiyue WANG, Shenzhen (CN); Zhen ZHOU, Shenzhen (CN); Zhiyun ZHONG, Shenzhen (CN)

(21) Appl. No.: 15/603,538

(22) Filed: May 24, 2017

Related U.S. Application Data
(63) Continuation of application No. PCT/CN2014/092151, filed on Nov. 25, 2014.

(51) Int. Cl. G02B 6/38; G02B 6/40; G02B 6/32

(52) U.S. Cl. CPC G02B 6/3885; G02B 6/3863; G02B 6/3878; G02B 6/32; G02B 6/3882; G02B 6/40

(57) ABSTRACT

An optical fiber connector includes: a plug assembly holding an optical fiber ribbon. The optical fiber ribbon includes bare fibers with ground end faces. The plug assembly includes a precision guiding device and a fixing device. The precision guiding device positions the bare fibers, the fixing device holds the optical fiber ribbon, and the precision guiding device and the fixing device are detachably connected to each other.

The present disclosure is a continuation application of PCT International patent application No. PCT/CN2014/092151, filed on Nov. 25, 2014 and entitled “OPTICAL FIBER CONNECTOR PLUG AND ASSEMBLY METHOD THEREFOR,” the entire contents of which are incorporated herein by reference.

### TECHNICAL FIELD

The present disclosure relates to the field of optical communication, and particularly, to an optical fiber connector plug and a method for assembling the optical fiber connector plug.

### BACKGROUND

Conventional sockets for multi-core optical fiber connectors, for example, MT sockets, include one or more rows of through holes for the insertion of the optical fibers. The optical fibers are inserted into and are cured with the sockets using a curing adhesive, and then, front ends of the optical fibers is precisely ground and polished so as to meet the operating requirements. The structure and manufacturing process pose high requirements on the protrusion length of the optical fibers in the through holes of the sockets and the grinding uniformity of geometrical shape. Once an optical fiber in a certain through hole fails to satisfy the requirements, the entire connector must be scrapped, leading to the increase of costs of the multi-core optical fiber connectors. In addition, guide pins, which are assembled together with the MT sockets, have a high accuracy requirement, and thus are difficult to be manufactured.

### SUMMARY

An embodiment of the present disclosure provides an optical fiber connector plug. The optical fiber connector plug includes: a plug assembly holding an optical fiber ribbon. The optical fiber ribbon includes bare fibers with ground end faces. The plug assembly includes a precision guiding device and a fixing device. The precision guiding device positions the bare fibers, the fixing device holds the optical fiber ribbon, and the precision guiding device and the fixing device are detachably connected to each other.

Another embodiment of the present disclosure provides a method for assembling the aforesaid optical fiber connector plug. The method includes:

assembling the fixing device and the precision guiding device together; and

allowing the optical fiber ribbon to run through the fixing device, matching the bare fibers with the precision guiding device, and fixing the optical fiber ribbon and the fixing device together.

Still another embodiment of the present disclosure provides a method for assembling the aforesaid optical fiber connector plug. The method includes:

inserting the guiding pins into the counter bores correspondingly;

inserting an end of the locating unit into the clamping groove, with an end face of the end of the locating unit touching end faces of the guiding pins out of the counter bores;

installing the lens unit on an end face of the socket, with the guiding pins inserted into the locating holes correspondingly;

allowing the optical fiber ribbon sheathed with the plastic sheath to run through the locating unit;

securing the plastic sheath to the locating unit;

matching the bare fibers having the ground end faces with the guide grooves and the micropore array, with the ground end faces being out of the micropore array and butting against the inner surface of the lens unit, so as to bend the bare fibers in the precision guiding device;

fixing the bare fibers of the optical fiber ribbon in the fixing grooves; and

pressing the cover plate onto the fixing grooves, with the cover plate positioned on the locating unit.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exploded view of an optical fiber connector plug in accordance with an embodiment of the present disclosure;

FIG. 2 is a cut-away view of the optical fiber connector plug of FIG. 1;

FIG. 3 is an assembling view of the optical fiber connector plug of FIG. 1, with a lens unit being removed;

FIG. 4 is a prospective view of a precision guiding device of the optical fiber connector plug of FIG. 1; and

FIGS. 5A-5D are prospective views illustrating successive stages of a method for assembling the optical fiber connector plug of FIG. 1.

### DETAILED DESCRIPTION

The technical schemes of the present disclosure are further illustrated in combination with the drawings and specific embodiments.

### EXAMPLE 1

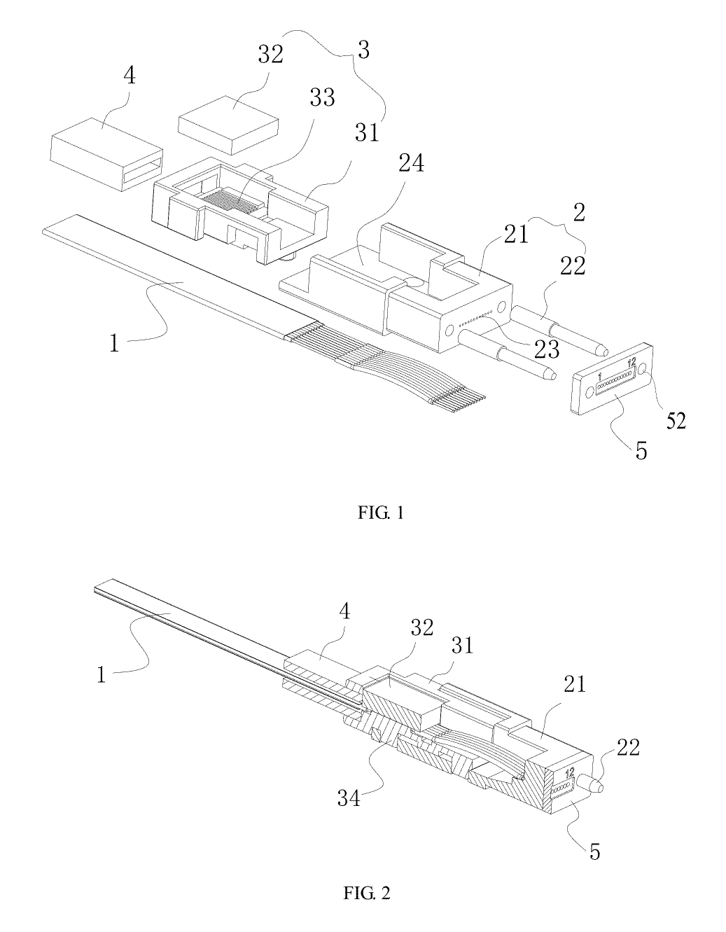

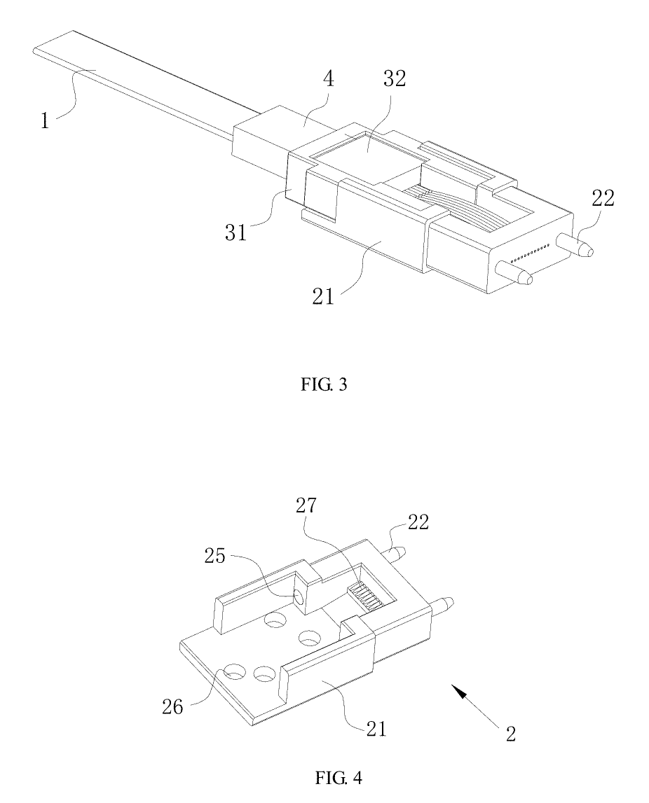

Referring to FIGS. 1-4, an embodiment of an optical fiber connector plug includes a plug assembly for engaging with an optical fiber ribbon 1. The plug assembly includes a precision guiding device 2 and a fixing device 3 detachably connected to the precision guiding device 2. The precision guiding device 2 is configured to precisely position bare fibers of the optical fiber ribbon 1, with end faces of the bare fibers being ground. The fixing device 3 is configured to hold the optical fiber ribbon 1.

The precision guiding device 2 defines a micropore array 23 which is integratedly formed with the precision guiding device 2. The micropore array 23 is defined in an end face of the precision guiding device 2. The precision guiding device 2 also defines guide grooves 27. Each guide groove 27 is coaxially aligned with a corresponding micropore of the micropore array 23. The guide grooves 27 and the micropore array 23 are in clearance fit with the bare fibers. The ground end faces of the bare fibers are exposed out of the end face of the precision guiding device 2 by between 0.01 and 0.3 mm.

The fixing device 3 includes a locating unit 31 and a cover plate 32. The locating unit 31 defines a longitudinal groove and one end of a bottom surface of the longitudinal groove defines fixing grooves 33 for fixing the bare fibers of the optical fiber ribbon 1. The fixing grooves 33 are uniformly positioned parallel to each other. The cover plate 32 covers and presses on the fixing grooves 33 and is received in the locating unit 31. The precision guiding device 2 includes a socket 21 and two guiding pins 22. The socket 21 includes two sidewalls and defines two counter bores 25, with each counter bores 25 running all the way through a corresponding one of the two sidewalls. Each guiding pin 22 is inserted into a corresponding one of the two counter bores 25. Micropores of the micropore array 23 run through one end of the socket 21 and are in clearance fit with the bare fibers. The socket 21 defines a clamping groove 24. The clamping groove 24 is in communication with the micropores of the micropore array 23 and the guide grooves 27. An end of the locating unit 31 is inserted into the clamping groove 24, and an end face of the end of the locating unit 31 touches an end face of the guiding pins 22 out of the counter bores 25. A bottom surface of the clamping groove 24 defines through holes 26. The locating unit 31 includes positioning columns 34 extending from a bottom plate of the locating unit 31. The through holes 26 accommodate the positioning columns 34 correspondingly. The optical fiber ribbon 1 is sheathed with a plastic sheath 4, and the plastic sheath 4 is inserted into one end of the locating unit 31.

Based on the aforesaid structure, the socket 21 and the locating unit 31 are clamped with each other to form an integrated structure, and meanwhile, the cover plate 32 positioned above the fixing grooves 33 defined on the locating unit 31 can tightly press the bare fibers in the fixing grooves 33. In some alternative embodiments, the fixation of the bare fiber can be achieved by clamping, buckling, or the like, herein no need to describe in detail.

An embodiment of the present disclosure also provides a method for assembling the aforesaid optical fiber connector plug, the method includes:

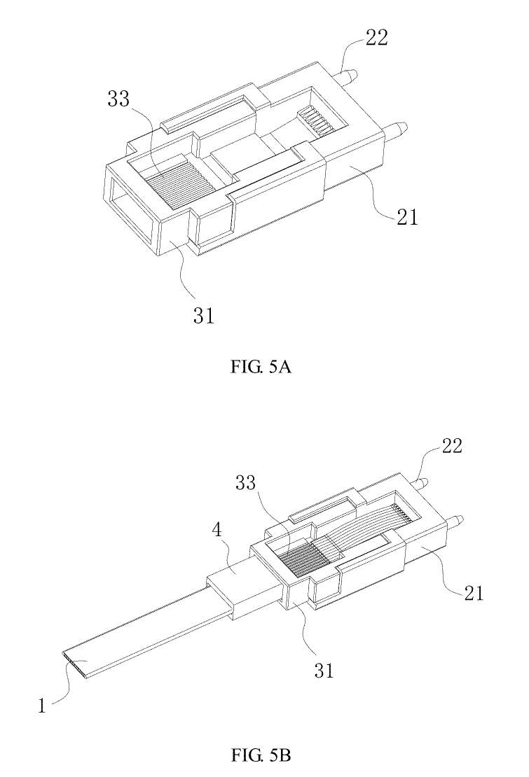

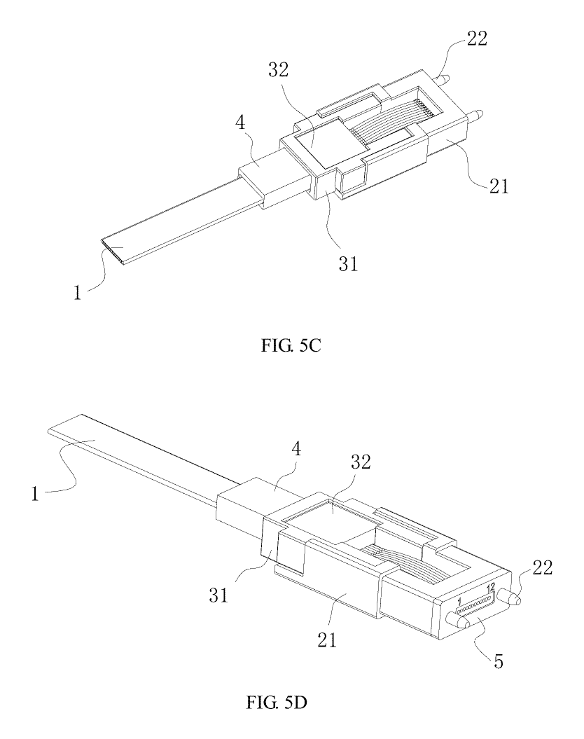

1) Assembling the fixing device 3 and the precision guiding device 2 together; as shown in FIG. 5A, the fixing device 3 includes the locating unit 31 and the cover plate 32, the precision guiding device 2 includes the socket 21 and the guiding pins 22, in assembling, an end of the locating unit 31 is clamped into the clamping groove 24 located on an end of the socket 21, so that the fixing device 3 and the precision guiding device 2 are stably and reliably connected to form an integrated structure.

2) Allowing the optical fiber ribbon 1 to run through the fixing device 3, matching the bare fibers having the ground end faces with the precision guiding device 2, and tightly fixing the optical fiber ribbon 1 to the fixing device 3. As shown in FIGS. 5B and 5C, the micropore array 23 and the guide grooves 27 are in clearance fit with the bare fibers having the ground end faces, and the ground end faces are exposed out of the end face of the precision guiding device 2 by between 0.01 and 0.3 mm, preferably, 0.2 mm. In addition, in some embodiments, prior to assembling the optical fiber ribbon 1 to the fixing device 3 and the precision guiding device 2, the length of the optical fiber ribbon 1 may be determined, and then the optical fiber ribbon fiber 1 is peeled in sections, that is, a section of the optical fiber ribbon 1 is peeled to form a first bare fiber section which has the ground end faces, the first bare fiber section is inserted to the guide groove 27 and the micropore array 23 of the precision guiding device 2, another section of the optical fiber ribbon 1 is peeled to form a second bare fiber section, the second bare fiber section is fixed in the fixing grooves 33 on the locating unit 31 by using an adhesive, and then the cover plate 32 is arranged and pressed on the fixing grooves 33. As a result, the optical fibers of the optical fiber ribbon 1 are fixed stably and reliably, and the bare fibers having the ground end faces can be positioned precisely, so that it is unnecessary to perform additional processing on the exposed end of the bare fibers after assembly, thus reducing the requirements for facilities, and greatly saving the production costs.

### EXAMPLE 2

As shown in FIGS. 1-4, another embodiment of an optical fiber connector plug includes a plug assembly configured to engage with an optical fiber ribbon 1, and the optical fiber ribbon 1 includes bare fibers with ground end faces. The plug assembly includes a precision guiding device 2 and a fixing device 3. The precision guiding device 2 is configured to precisely position the bare fibers. The fixing device 3 is configured to hold the optical fiber ribbon 1. The precision guiding device 2 and the fixing device 3 are detachably connected to each other.

The precision guiding device 2 includes a micropore array 23 which is integratedly formed with the precision guiding device 2. The micropore array 23 is defined in an end face of the precision guiding device 2. The precision guiding device 2 also defines guide grooves 27. Each guide groove 27 is coaxially aligned with a corresponding micropore of the micropore array 23. The guide grooves 27 and the micropore array 23 are in clearance fit with the bare fibers. The ground end faces of the bare fibers are exposed out of the end face of the precision guiding device 2 by between 0.01 and 0.3 mm.

The plug assembly further includes a lens unit 5 closely attached to an end face of the precision guiding device 2. An inner surface of the lens unit 5 tightly presses the ground end faces of the bare fibers and pushes the bare fibers backwards, so as to bend the optical fiber ribbon 1 in the precision guiding device 2.

The fixing device 3 includes a locating unit 31 and a cover plate 32. The locating unit 31 defines a longitudinal groove and one end of a bottom surface of the longitudinal groove defines fixing grooves 33 for fixing the bare fibers of the optical fiber ribbon 1. The fixing grooves 33 are uniformly positioned parallel to each other. The cover plate 33 covers and presses on the fixing grooves 33.

The precision guiding device 2 includes a socket 21 and two guiding pins 22. The socket 21 includes two sidewalls and defines two counter bores 25, with each counter bores 25 running all the way through a corresponding one of the two sidewalls. Each guiding pin 22 is inserted into a corresponding one of the two counter bores 25. Micropores of the micropore array 23 run through one end of the socket 21 and are in clearance fit with the bare fibers. The socket 21 defines a clamping groove 24. The clamping groove 24 is in communication with the micropores of the micropore array 23 and the guide grooves 27. An end of the locating unit 31 is inserted into the clamping groove 24, and an end face of the end of the locating unit 31 touches an end face of the guiding pins 22 out of the counter bores 25. A bottom surface of the clamping groove 24 defines through holes 26. The locating unit 31 includes positioning columns 34 extending from a bottom plate of the locating unit 31. The through holes 26 accommodate the positioning columns 34 correspondingly. The optical fiber ribbon 1 is sheathed with a plastic sheath 4, and the plastic sheath 4 is inserted into one end of the locating unit 31.

Existing MELEX products are evolved on the basis of MPO sockets in the prior arts, and the MPO sockets have the following defects: because the heights of the bare fibers exposed out of one end of the socket are nonuniform, the focal plane of lenses installed on the end face of the socket is deviated from the end faces of the bare fibers, thus, the emitted beam will diverge (parallel light is ideal), and a receiving end fails to completely couple the optical signals to the optical fibers in the receiving end, leading to the loss of the optical signals, i.e., increasing the insertion loss of the entire optical fiber connector. Likewise, at the receiving end, if the end faces for receiving the optical fibers are not in the focal plane of the lenses, the optical energy also loses, which further increases the insertion loss of the fiber connector.

To overcome the aforesaid defects, embodiments of the present disclosure adopt the abovementioned structure for the optical fiber connector plug, which can effectively solve the problem of nonuniform height of multicore fibers in the lens-type fiber connector, prevent the insertion loss caused by the nonuniform fiber height, ensure the coupling efficiency of the optical fibers and the lenses, and reduce the insertion loss of the entire connector scheme. Using the aforesaid technical solution, the present disclosure updates the conventional fixing modes of optical fibers (conventionally, the front end is fixed), a rear end fixing scheme is adopted (the fixing modes may be variable, such as fixing using adhesive, fixing by clamping, or the like), so that the front ends of the optical fibers can freely move along the axial direction. Upon fixing the optical fibers, each optical fiber is provided with a fixed length, make sure the optical fiber is exposed out of the end face of the socket 21, when assembly, the lens unit 5 butts against the bare fibers backwards, so the optical fiber ribbon 1 is bent in the socket 21, thus ensuing the favorable fitting of the ground end faces of the bare fibers with the lens unit 5. The present disclosure can simplify the assembly process and reduce the costs of the lens-type optical fiber connectors. Conventionally, gaps often exist between the lenses and the optical fibers, and require to be filled up using an adhesive having specific refractive index so as to reduce the coupling loss between the optical fibers and the lenses. In the present disclosure, a microbend structure is employed (suppose the inner surface of the lens unit 5 is the focal plane, when the tail on one end of the optical fiber ribbon 1 is fixed, the ground end faces of the bare fibers is preset to be 0.2 mm higher than the end face of the socket 21, upon assembling the lens unit 5, the lens unit 5 pushes the bare fibers backwards, due to the bending stress of the bare fibers, the ground end faces of the bare fiber can totally be attached to the focal plane of the lens unit 5, thus, the optical beam penetrates through the lens unit 5 and emits in parallel), there is no specific requirement on the distance between the lens unit 5 and the bare fibers, so the fixing mode of the lens unit 5 can present in various forms, such as bonding by adhesive, clamping, or the like, which are not described in detail.

In some embodiments, as shown in FIGS. 5A-5D, a method for assembling the aforesaid optical fiber connector plug is provided, the method includes the following steps:

a. Inserting the guiding pins 22 into the counter bores 25 in the two sidewalls, the end faces of the guiding pins 22 slightly protrudes out of the end face of the counter bores 25, so as for the fixing device 31 to tightly press the guiding pins 22. Compared to the conventional processing mode of the integration of the guiding pins and the socket, the structure of the present disclosure can be more conveniently manufactured, and provide a much higher installation accuracy of the guiding pins 22.

b. Inserting an end of the locating unit 31 into the clamping groove 24 located on an end of the socket 21, and allowing an end face of the locating unit 31 to butt against the end faces of the guiding pins 22 out of the counter bores 25, with the through holes 26 accommodating the positioning columns 34 arranged on the bottom plate of the locating unit 31, the structure can effectively limit the freedom degree of the locating unit 31 and the socket 21, ensure the tight fit of the locating unit 31 and the socket 21 to form an integral whole, thus facilitating the disassembly of the locating unit 31 and the socket 21 as well as the installation of the optical fiber ribbon 1.

c. Installing the lens unit 5 on an end face of the socket 21, two ends of the lens unit 5 define locating holes 52 corresponding to the guiding pins 22 in shape and position, the guiding pins 22 are inserted into the locating holes 52 correspondingly, the inner surface of the lens unit 5 is coated with a glue configured to tightly attach to the end face of the socket 21, an overflow groove is arranged around the glue coating area to accommodate excess glue, so as not to affect the appearance of other elements.

d. Allowing the optical fiber ribbon 1 sheathed with the plastic sheath 4 to run through the locating unit 31, and matching one end of the plastic sheath 4 with one end of the locating unit 31, the end face of the locating unit 31 defines an installation groove corresponding to the plastic sheath 4, which facilitates the assembly of the plastic sheath 4 and the locating unit 31; the structure reduces the stress between the optical fiber ribbon 1 and the locating unit 31, which is favorable to the fixation of the optical fiber ribbon 1.

In some exemplary embodiments, matching the bare fibers having the ground end faces with the guide grooves 27 and the micropore array 23, exposing the bare fibers out of the micropore array 23 and allowing the ground end faces of the bare fibers to closely butt against the inner surface of the lens unit 5, so as to bend the optical fiber ribbon 1 in the precision guiding device 2, thus ensuring the tight fit between the ground end faces of the bare fibers and the focal plane of the lens unit 5.

e. Assembling and fixing the bare fibers of the optical fiber ribbon 1 in the fixing grooves 33 using an adhesive, allowing the cover plate 32 to press on the fixing grooves 33, and tightly fixing the cover plate 32 with the locating unit 31.

In some alternative embodiments, following the assembly of the socket 21 and the fixing device 31, matching the bare fibers with the guide grooves 27 and the micropore array 23 of the socket 21 and exposing the ground end faces of the bare fibers out of the end face of the socket 21 by 0.2 mm, and then assembling and tightly fixing the bare fibers into the fixing grooves 33, finally, installing the lens unit 5 on the end face of the socket 21 and ensuring the inner surface of the lens unit 5 to butt against the ground end faces of the bare fibers, so as to bend the bare fibers in the precision guiding device 2, thus ensuring the tight fit between the ground end faces of the bare fibers and the inner surface of the lens unit 5.

After the aforesaid assembly steps, an integrated optical fiber connector plug is obtained, which can precisely and effectively fix the optical fiber ribbon 1, enable the ground end faces of the bare fibers at the end face of the socket 21 to tightly fit with the inner surface of the lens unit 5, and prevent the loss of the optical signals caused by the phenomenon that the optical signals cannot be fully coupled to the optical fibers in the receiving end due to the nonuniform fiber height. In addition, compared with conventional assembly process that the bare fibers are inserted into and are cured with the socket using a curing adhesive and the front end of the socket is precisely ground and polished so as to meet the operating requirements, the method for assembling the optical fiber connector plug of the present disclosure greatly reduces the process difficulty, reduces the fault rate of the plugs, thus effectively reducing the production costs of the plugs.

Finally it shall be noted that, the above embodiments are only used to describe but not to limit the technical solutions of the present disclosure; and within the concept of the present disclosure, technical features of the above embodiments or different embodiments may also be combined with each other, the steps may be implemented in an arbitrary order, and many other variations in different aspects of the present disclosure described above are possible although, for purpose of simplicity, they are not provided in the details. Although the present disclosure has been detailed with reference to the above embodiments, those of ordinary skill in the art shall appreciate that modifications can still be made to the technical solutions disclosed in the above embodiments or equivalent substations may be made to some of the technical features, and the corresponding technical solutions will not depart from the scope of the present disclosure due to such modifications or substations.

What is claimed is:

1. An optical fiber connector plug, comprising a plug assembly holding an optical fiber ribbon, the optical fiber ribbon comprising bare fibers with ground end faces, the plug assembly comprising a precision guiding device and a fixing device, the precision guiding device positioning the bare fibers, the fixing device holding the optical fiber ribbon, and the precision guiding device and the fixing device detachably connected to each other.

2. The optical fiber connector plug of claim 1, wherein the precision guiding device defines a micropore array, the micropore array is in clearance fit with the bare fibers, and the ground end faces extend out of the fixing device through the micropore array.

3. The optical fiber connector plug of claim 2, wherein the ground end faces extend out of the fixing device by 0.01-0.3 mm.

4. The optical fiber connector plug of claim 2, further comprising a lens unit attached to an end face of the precision guiding device, wherein an inner surface of the lens unit presses the ground end faces of the bare fibers and pushes the bare fibers backwards, so as to bend the optical fiber ribbon in the precision guiding device.

5. The optical fiber connector plug of claim 4, wherein the fixing device comprises a locating unit and a cover plate, the locating unit defines a plurality of fixing grooves, the bare fibers are receiving in the fixing grooves, and the cover plate presses on the fixing grooves.

6. The optical fiber connector plug of claim 5, wherein the precision guiding device comprises a socket and guiding pins, the socket defines counter bores, the lens unit defines locating holes, and the guiding pins are inserted into the counter bores and the locating holes correspondingly.

7. The optical fiber connector plug of claim 6, wherein the socket defines guide grooves, each guide groove are coaxially aligned with a micropore of the micropore array, and the guide grooves are in clearance fit with the bare fibers.

8. The optical fiber connector plug of claim 7, wherein the socket defines a clamping groove, an end of the locating unit is inserted into the clamping groove, and an end face of the end of the locating unit touches end faces of the guiding pins out of the counter bores.

9. The optical fiber connector plug of claim 8, wherein the socket defines through holes in a bottom surface of the clamping groove, the locating unit comprises positioning columns, the positioning columns are arranged on a bottom plate of the locating unit, and the positioning columns are inserted into the through holes correspondingly.

10. The optical fiber connector plug of claim 9, further comprising a plastic sheath, wherein an end of the optical fiber ribbon fiber is sheathed with the plastic sheath and the plastic sheath is positioned on the locating unit.

11. A method for assembling the optical fiber connector plug of claim 1, comprising:
assembling the fixing device and the precision guiding device together; and
allowing the optical fiber ribbon to run through the fixing device, matching the bare fibers with the precision guiding device, and fixing the optical fiber ribbon and the fixing device together.

12. A method for assembling the optical fiber connector plug of claim 10, comprising:
inserting the guiding pins into the counter bores correspondingly;
inserting an end of the locating unit into the clamping groove, with an end face of the end of the locating unit touching end faces of the guiding pins out of the counter bores;
installing the lens unit on an end face of the socket, with the guiding pins inserted into the locating holes correspondingly;
allowing the optical fiber ribbon sheathed with the plastic sheath to run through the locating unit;
securing the plastic sheath to the locating unit;
matching the bare fibers having the ground end faces with the guide grooves and the micropore array, with the ground end faces being out of the micropore array and butting against the inner surface of the lens unit, so as to bend the bare fibers in the precision guiding device;
fixing the bare fibers of the optical fiber ribbon in the fixing grooves; and
pressing the cover plate onto the fixing grooves, with the cover plate positioned on the locating unit.
